(19) United States
(12) Patent Application Publication
(10) Pub. No.: US 2021/0405324 A1
(43) Pub. Date: Dec. 30, 2021

(54) OPTICAL IMAGING SYSTEM, IMAGE CAPTURING APPARATUS, AND ELECTRONIC DEVICE

(71) Applicant: JIANGXI JINGCHAO OPTICAL CO., LTD., Nanchang (CN)

(72) Inventors: Qi SONG, Nanchang (CN); Ming LI, Nanchang (CN); Han XIE, Nanchang (CN); Binbin LIU, Nanchang (CN)

(21) Appl. No.: 17/471,827

(22) Filed: Sep. 10, 2021

Related U.S. Application Data
(63) Continuation of application No. PCT/CN2019/104991, filed on Sep. 9, 2019.

(51) Int. Cl. G02B 13/00; G02B 9/16; G02B 5/20

(52) U.S. Cl. CPC G02B 13/0035; H04N 5/2253; G02B 5/208; G02B 9/16

(57) ABSTRACT

An optical imaging system is provided. The optical imaging system includes, from an object side to an image side, a first lens with a positive refractive power, a second lens with a negative refractive power, a third lens with a positive refractive power, and an infrared cut-off filter. The infrared cut-off filter is located between the first lens and the second lens or between the second lens and the third lens. In this way, a miniaturization of the optical imaging system can be achieved, a step of the optical imaging system can be reduced, and stability of an assembly of the optical imaging system can be improved so as to improve a production yield of the optical imaging system and lower a cost. An image capturing apparatus and an electronic device are further provided.

### CROSS-REFERENCE TO RELATED APPLICATIONS

The present application is a continuation of International Application No. PCT/CN2019/104991, filed on Sep. 9, 2019, the disclosure of which is hereby incorporated by reference in its entirety.

### TECHNICAL FIELD

This disclosure relates to the field of optical imaging technology, and more particularly to an optical imaging system, an image capturing apparatus, and an electronic device.

### BACKGROUND

With the widespread availability of portable mobile electronic products such as mobile phones and wearable devices, users have increasing requirements for miniaturization the mobile electronic products, same as a shooting apparatus and camera lenses loaded thereon. Generally, it is easy for a three-piece camera lens to achieve miniaturization due to a relatively low number of lenses and a short total length of an optical imaging system.

In this disclosure, a three-piece lens group is adopted. Different shapes formed by aspherical surfaces can be used to realize a good optical performance. An infrared cut-off filter in the middle, instead the rear, of the optical imaging system is adopted to achieve a reduced mechanical back focal length of the lens, which is beneficial to realizing miniaturization. The infrared cut-off filter is located between two adjacent lenses with a large air gap therebetween, such that the large air gap is separated into two relatively small air gaps, a step (also called mismatch gap) between parts for installing elements can be reduced, and elements can be stably arranged relative to each other during assembly, thereby achieving a stable actual production yield and a low cost.

### SUMMARY

In a first aspect, a three-piece optical imaging system is provided, which can ensure miniaturization of the optical imaging system, reduce steps (also called mismatch gaps) of the lenses of the optical imaging system, and improve a production yield of the optical imaging system.

An optical imaging system is provided. The optical imaging system includes, in order from an object side to an image side, a first lens with a positive refractive power, a second lens with a negative refractive power, a third lens with a positive refractive power, and an infrared cut-off filter, where the infrared cut-off filter is located between the first lens and the second lens or between the second lens and the third lens.

Both an object-side surface and an image-side surface of each of the first lens, the second lens, and the third lens are aspheric, and at least one of the object-side surface or the image-side surface of the third lens has at least one inflection point. The aspheric lenses are adopted, such that it is easy to form the lens in other shapes other than a spherical shape and obtain more control variables. As such, it is beneficial to reducing aberration and obtaining high-quality image with a relatively low number of lenses. As such, the number of the lenses can be reduced, and the miniaturization of the optical imaging system can be realized. At least one of the object-side surface or the image-side surface of the third lens has the at least one inflection point, where the inflection point can be used to correct the aberration of an off-axis field of view and restrain an incident angle of a ray to an imaging surface so as to match a photosensitive element more precisely.

The object-side surface of the first lens is convex near the optical axis and a periphery of the object-side surface of the first lens. The image-side surface of the first lens is concave near the optical axis and the periphery of the image-side surface of the first lens. Aspheric setting of the object-side surface and the image-side surface of the first lens can facilitate light converging and image formation.

The object-side surface of the second lens is concave near the optical axis and the periphery of the object-side surface of the second lens. The image-side surface of the second lens is convex near the optical axis and the periphery of the image-side surface of the second lens. The second lens in this disclosure has the negative refractive power, which can effectively correct the spherical aberration formed by the first lens and improve a resolution of the optical imaging system.

The object-side surface of the third lens is convex near the optical axis and the periphery of the object-side surface of the third lens. The image-side surface of the third lens is concave near the optical axis and convex near the periphery of the image-side surface of the third lens. Alternatively, the object-side surface of the third lens is convex near the optical axis and concave near the periphery of the object-side surface of the third lens. The image-side surface of the third lens is concave near the optical axis and convex near the periphery of the image-side surface of the third lens. The third lens in this disclosure can effectively reduce field curvature and distortion of the optical imaging system and improve imaging quality.

The optical imaging system further includes a stop. The stop is located at the object side of the first lens, which can enable the optical imaging system a telecentric effect and increase efficiency of receiving images of the photosensitive element.

The optical imaging system further includes a protective glass. The protective glass is located between the third lens and the imaging surface. The protective glass is used to protect the photosensitive element on the imaging surface to realize a dustproof effect.

The optical imaging system satisfies the expression 72°<fov<91°, where fov represents a maximum angle of view of the optical imaging system. When a value of fov ranges from 72° to 91°, the optical imaging system can capture an image with a wide enough angle of view to facilitate observation of objects around.

The optical imaging system satisfies the expression 2.2≤FNO≤3.0, where FNO represents an f-number of the optical imaging system. The optical imaging system with the smaller f-number can realize a good photographic performance, which is beneficial to achieving a high relative illumination.

The optical imaging system satisfies the expression TL/ImgH<1.7, where TL represents a distance from the object-side surface of the first lens to the imaging surface on the optical axis, and ImgH represents half of a diagonal length of an effective pixel area on the imaging surface. When the value of TL/ImgH is less than 1.7, it is beneficial to realizing the miniaturization of the optical imaging system.

The optical imaging system satisfies the expression 0.7<f/f1<1, where f represents an effective focal length of the optical imaging system, and f1 represents an effective focal length of the first lens. Proper arrangement of the effective focal length of the first lens can facilitate a shortening of a total length of the optical imaging system and avoid an excessively large inclination angle to the surfaces so as to ensure good manufacturability of the first lens.

The optical imaging system satisfies the expression SD1≤0.47, where SD1 represents half of a maximum optical clear aperture of the object-side surface of the first lens. When the value of SD1 is less than or equals 0.47, since the maximum optical clear aperture of the object-side surface of the first lens is relatively small, a small head structure of the optical imaging system can be realized, which is beneficial to realizing the miniaturization of the optical imaging system.

The optical imaging system satisfies the expression 0.17<ET12<0.3, where ET12 represents a distance on the optical axis from the image-side surface of the first lens to a position where the object-side surface of the second lens has a maximum optical clear aperture. When the value of ET12 ranges from 0.17 to 0.3, the optical imaging system can be assembled in a stable manner, which overcomes a problem that there are large level differences among steps within a lens barrel and lowers a cost of the optical imaging system.

The optical imaging system satisfies the expression 0.4<ET23<0.8, where ET23 represents a distance on the optical axis from the image-side surface of the second lens to a position where the object-side surface of the third lens has a maximum optical clear aperture. Air space among the lenses of the three-piece optical imaging system is relatively large, which is not beneficial to forming the lens barrel. In addition, the production yield is unstable due to a large step (also called mismatch gap). The infrared cut-off filter is located between the second lens and the third lens, which can reduce the air space between the second lens and the third lens and make optical imaging system be assembled in a stable manner.

The optical imaging system satisfies the expression 0.57<BF<0.82, where BF represents a distance from a vertex of the image-side surface of the third lens to the imaging surface on the optical axis. When the value of BF ranges from 0.57 to 0.82, the optical imaging system can be ensured a sufficient focus range and miniaturization.

In a second aspect, an image capturing apparatus is provided. The image capturing apparatus includes the optical imaging system in any of the above implementations and the photosensitive element located on the imaging surface of the optical imaging system.

In a third aspect, an electronic device is provided. The electronic device includes a body and the image capturing apparatus as described above. The image capturing apparatus is installed on the body.

Therefore, the infrared cut-off filter is located between the first lens and the second lens or between the second lens and the third lens of the three-piece optical imaging system, the miniaturization of the optical imaging system is achieved, the step of the optical imaging system during assembly is reduced, and the stability of assembling the optical imaging system can be improved. As such, the production yield of the optical imaging system is improved and the cost is lowered.

### BRIEF DESCRIPTION OF THE DRAWINGS

Structures, features, and functions of this disclosure are more clearly described hereinafter, with reference to the accompanying drawings and the specific implementations.

FIG. 1 is a schematic structural diagram of an optical imaging system according to an implementation of this disclosure.

FIG. 2 illustrates a spherical aberration curve, an astigmatic curve, and a distortion curve of the optical imaging system of FIG. 1, from left to right.

FIG. 3 is a schematic structural diagram of an optical imaging system according to an implementation of this disclosure.

FIG. 4 illustrates a spherical aberration curve, an astigmatic curve, and a distortion curve of the optical imaging system of FIG. 3, from left to right.

FIG. 5 is a schematic structural diagram of an optical imaging system according to an implementation of this disclosure.

FIG. 6 illustrates a spherical aberration curve, an astigmatic curve, and a distortion curve of the optical imaging system of FIG. 5, from left to right.

FIG. 7 is a schematic structural diagram of an optical imaging system according to an implementation of this disclosure.

FIG. 8 illustrates a spherical aberration curve, an astigmatic curve, and a distortion curve of the optical imaging system of FIG. 7, from left to right.

FIG. 9 is a schematic structural diagram of an optical imaging system according to an implementation of this disclosure.

FIG. 10 illustrates a spherical aberration curve, an astigmatic curve, and a distortion curve of the optical imaging system of FIG. 9, from left to right.

FIG. 11 is a schematic structural diagram of an optical imaging system according to an implementation of this disclosure.

FIG. 12 illustrates a spherical aberration curve, an astigmatic curve, and a distortion curve of the optical imaging system of FIG. 11, from left to right.

FIG. 13 is a schematic structural diagram of an image capturing apparatus according to an implementation of a second aspect of this disclosure.

FIG. 14 is a schematic structural diagram of an image capturing apparatus according to another implementation of a second aspect of this disclosure.

FIG. 15 is a schematic structural diagram of an electronic device according to an implementation of a third aspect of this disclosure.

### DETAILED DESCRIPTION

Technical solutions in implementations of this disclosure will be described clearly and completely hereinafter with reference to the accompanying drawings in the implementations of this disclosure. Apparently, the described implementations are merely some rather than all implementations of this disclosure. All other implementations obtained by those of ordinary skill in the art based on the implementations of this disclosure without creative efforts shall fall within the protection scope of this disclosure.

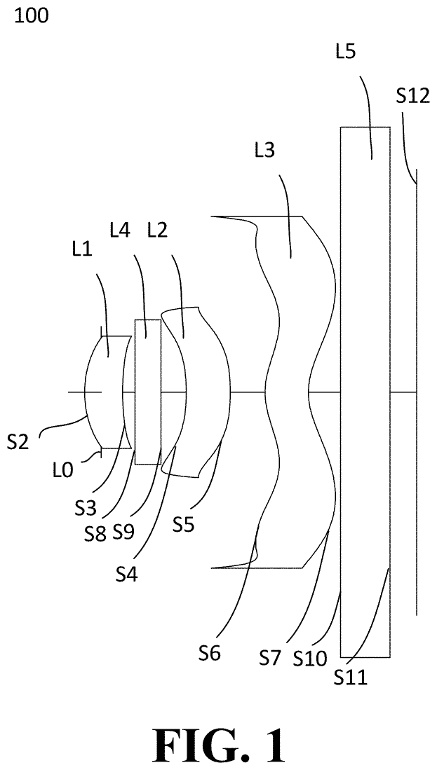

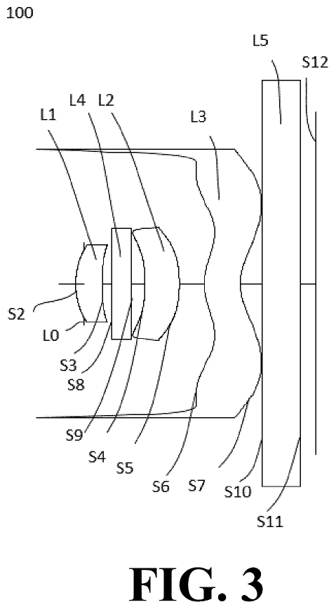

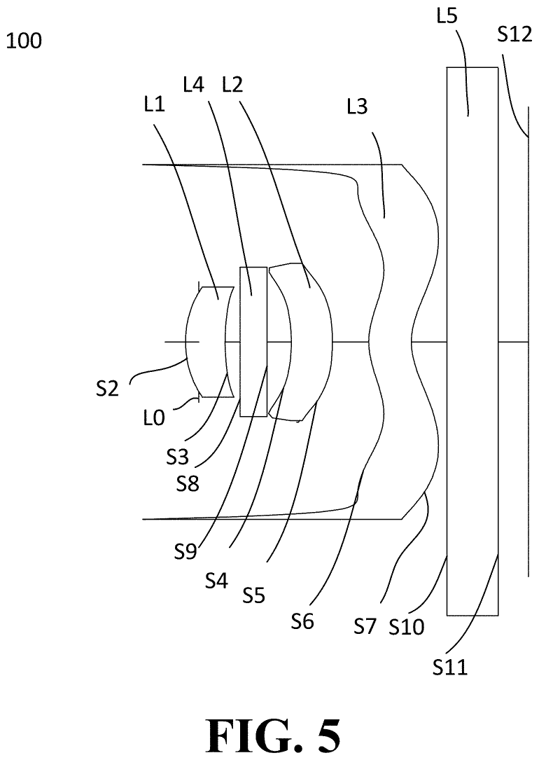

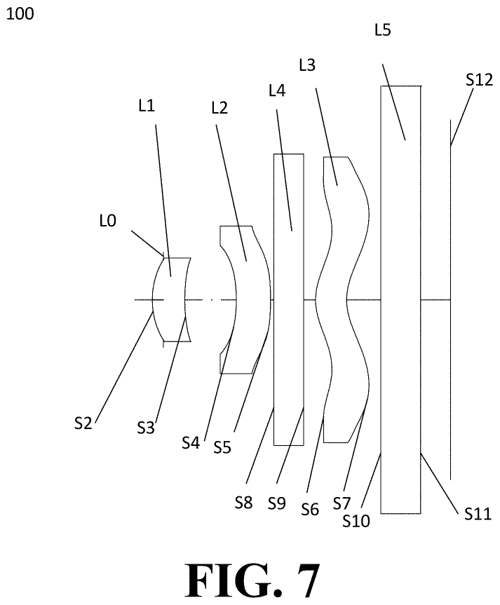

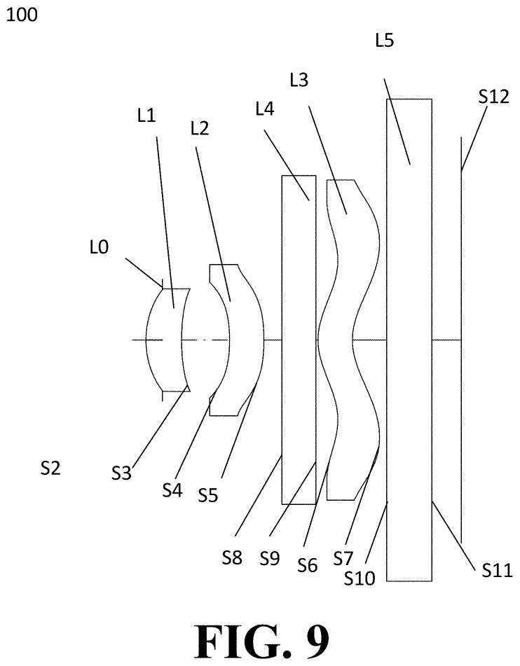

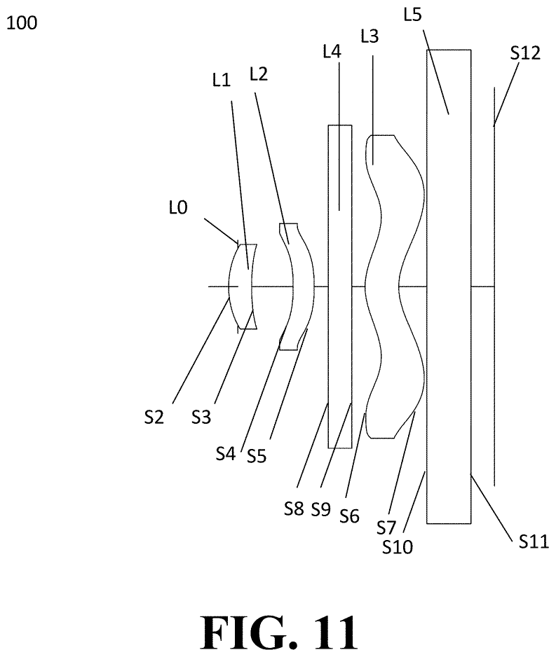

Referring to FIG. 1, FIG. 3, FIG. 5, FIG. 7, FIG. 9, and FIG. 11, an optical imaging system 100 is provided in a first aspect of this disclosure. The optical imaging system 100 includes, in order from an object side to an image side, a first lens L1 with a positive refractive power, a second lens L2 with a negative refractive power, and a third lens L3 with a positive refractive power. The optical imaging system 100 further includes an infrared cut-off filter L4. The infrared cut-off filter L4 is located between the first lens L1 and the second lens L2. Alternatively, the infrared cut-off filter L4 is located between the second lens L2 and the third lens L3.

In some implementations, the first lens L1 is made of plastic and has an object-side surface S2 and an image-side surface S3. Both the object-side surface S2 and the image-side surface S3 of the first lens L1 are aspheric. The object-side surface S2 of the first lens L1 is convex near an optical axis and a periphery of the object-side surface S2 of the first lens L1. The image-side surface S3 of the first lens L1 is concave near the optical axis and a periphery of the image-side surface S3 of the first lens L1. The first lens L1 is aspheric, which can facilitate light converging and image formation. It is easy to form the first lens in other shapes other than a spherical shape and obtain more control variables, which is beneficial to obtaining high-quality image with a relatively low number of lenses so that the miniaturization of the optical imaging system can be realized.

In some implementations, the second lens L2 is made of plastic and has an object-side surface S4 and an image-side surface S5. Both the object-side surface S4 and the image-side surface S5 of the second lens L2 are aspheric. The object-side surface S4 of the second lens L2 is concave near the optical axis and a periphery of the object-side surface S4 of the second lens L2. The image-side surface S5 of the second lens L2 is convex near the optical axis and convex near a periphery of the image-side surface S5 of the second lens L2. The second lens L2 has the negative refractive power, which can effectively correct spherical aberration formed by the first lens and improve a resolution of the optical imaging system. The second lens L2 is an aspheric lens, it is easy to form the second lens in other shapes other than the spherical shape and obtain more control over the variables, which is beneficial to reducing the aberration and obtaining the high-quality image with the fewer lenses. As such, the number of the lenses can be reduced, and the miniaturization of the optical imaging system can be realized.

In some implementations, the third lens L3 is made of plastic and has an object-side surface S6 and an image-side surface S7. Both the object-side surface S6 and the image-side surface S7 of the third lens L3 are aspheric. As illustrated in FIG. 1, FIG. 3, FIG. 9, and FIG. 11, the object-side surface S6 of the third lens L3 is convex near the optical axis and a periphery of the object-side surface S6 of the third lens L3. An image-side surface S7 of the third lens L3 is concave near the optical axis and convex near a periphery of the image-side surface L7 of the third lens L3. In other implementations, as illustrated in FIG. 5 and FIG. 7, the object-side surface S6 of the third lens L3 is convex near the optical axis and concave near the periphery of the object-side surface S6 of the third lens L3. The image-side surface L7 of the third lens L3 is concave near the optical axis and convex near the periphery of the image-side surface S7 of the third lens L3. The third lens L3 in this disclosure can effectively reduce field curvature and distortion of the optical imaging system and improve imaging quality. The third lens L3 is an aspheric lens, it is easy to form the third lens in other shapes other than the spherical shape and obtain more control over the variables, which is beneficial to reducing the aberration and obtaining the high-quality image with the fewer lenses. As such, the number of the lenses can be reduced, and the miniaturization of the optical imaging system can be realized

The infrared cut-off filter L4 is made of plastic and has an object-side surface S8 and an image-side surface S9. Both the object-side surface S8 and the image-side surface S9 of the infrared cut-off filter L4 are aspheric. In some implementations, as illustrated in FIG. 1, FIG. 3, and FIG. 5, the infrared cut-off filter L4 is located between the first lens L1 and the second lens L2. In other implementations. As illustrated in FIG. 7, FIG. 9, and FIG. 11, the infrared cut-off filter L4 is located between the second lens L2 and the third lens L3. The infrared cut-off filter is usually located at front of a photosensitive element to filter out light with a wavelength different from that of visible light and reduce or eliminate an ghost image (the ghost image refers to a duplicate image formed in vicinity of a focal plane of the optical imaging system caused by reflections from the surfaces of lens, which is dim and will not overlap with or offset with an original image), stray light, and other adverse factor to the image. In this disclosure, an infrared cut-off filter is located in the middle, instead the rear, of the optical imaging system to reduce the mechanical back focal length of the lens, which is beneficial to realizing the miniaturization design. The infrared cut-off filter is located between two adjacent lenses with a large air gap therebetween, a step between two adjacent elements can be reduced, and elements can be stably relative to each other during assembly, thereby realizing a stable actual production yield and a low cost.

The term “element” in this disclosure refers to a lens, a lens barrel, a light shielding sheet, a gasket of a camera, or a component of other lens products.

The infrared cut-off filter L4 is located between the first lens L1 and the second lens L2 or between the second lens L2 and the third lens L3 of the three-piece optical imaging system 100, the miniaturization of the optical imaging system 100 is achieved, the step of the optical imaging system 100 is reduced, and the stability of assembling the optical imaging system 100 can be improved. As such, the production yield of the optical imaging system 100 is improved and the cost is lowered.

In some implementations, at least one of the object-side surface S6 or the image-side surface S7 has at least one inflection point. The inflection point refers to a point where a radius of curvature changes from being negative to positive or from being positive to negative. The inflection point can be used to correct the aberration of an off-axis field of view and restrain an incident angle of a ray to an imaging surface so as to match the photosensitive element more precisely.

In some implementations, the optical imaging system 100 further includes a stop L0. The stop L0 is located at the object side of the first lens L1. Specifically, the stop L0 may be located on the object-side surface S2. Alternatively, the stop L0 is located between an object plane and the object-side surface S2, which means that the stop L0 will not contact directly with the object-side surface S2. When the stop L0 is located at the object side of the first lens L1, the optical imaging system 100 can be enabled a telecentric effect and increase efficiency of the photosensitive element receiving the image.

In some implementations, the optical imaging system 100 further includes a protective glass L5. The protective glass L5 is located between the third lens L3 and the imaging surface S12. The protective glass L5 is used to protect the photosensitive element on the imaging surface to realize a dustproof effect. The protective glass L5 has an object-side surface S10 and an image-side surface S11.

In some implementations, the optical imaging system 100 satisfies the expression 72°<fov<91°, where fov represents a maximum angle of view of the optical imaging system 100. In other words, fov may be any value ranging from 72° to 91°. For example, fov may be 73°, 75°, 77°, 79°, 82°, 85°, 88°, and 90°, etc. When a value of fov ranges from 72° to 91°, the optical imaging system can capture the image with a wide enough angle of view to facilitate observation of objects around.

In some implementations, the optical imaging system 100 satisfies the expression 2.2≤FNO≤3.0, where FNO represents an f-number of the optical imaging system. In other words, FNO may be any value ranging from 2.2 to 3.0. For example, FNO may be 2.2, 2.3, 2.4, 2.5, 2.6, 2.7, 2.8, 2.9, and 3.0, etc. The optical imaging system with the smaller f-number can realize a good photographic performance, which is beneficial to achieving a high relative illumination. The relative illumination refers to a ratio of the irradiance in the focal plane at off-axis field positions to the irradiance at the center of the field. In an optical imaging system, if the relative illumination is small, the illumination on the focal plane is uneven, which may easily lead to underexposure at some positions or overexposure at the center of the field and therefore adversely affect the imaging quality of optical devices.

In some implementations, the optical imaging system 100 satisfies the expression TL/ImgH<1.7, where TL represents a distance from the object-side surface of the first lens L1 to the imaging surface on the optical axis, or an total length of the optical imaging system, and ImgH represents half of a diagonal length of an effective pixel area on the imaging surface. In other words, TL/ImgH may be any value less than 1.7. For example, TL/ImgH may be 1.6, 1.5, 1.4, 1.2, 1.0, 0.8, 0.5, and 0.2, etc. When the value of TL/ImgH is less than 1.7, it is beneficial to realizing the miniaturization of the optical imaging system.

In some implementations, the optical imaging system 100 satisfies the expression 0.7<f/f1<1, where f represents an effective focal length of the optical imaging system, and f1 represents an effective focal length of the first lens L1. In other words, f/f1 may be any value ranging from 0.7 to 1. For example, f/f1 may be 0.75, 0.8, 0.83, 0.88, 0.92, 0.95, and 0.99, etc. Proper arrangement of the effective focal length of the first lens can facilitate a shortening of the total length of the optical imaging system and avoid an excessively large inclination angle to the surfaces so as to ensure good manufacturability of the first lens.

In some implementations, the optical imaging system 100 satisfies the expression SD1≤0.47, where SD1 represents half of a maximum optical clear aperture of the object-side surface of the first lens L1. In other words, SD1 may be any value less than 0.47. For example, SD1 may be 0.47, 0.42, 0.4, 0.35, 0.3, 0.2, and 0.1, etc. When the value of SD1 is less than or equals 0.47, since the maximum optical clear aperture of the object-side surface of the first lens is relatively small, a small head structure of the optical imaging system can be realized, which is beneficial to realizing the miniaturization of the optical imaging system.

In some implementations, the optical imaging system 100 satisfies the expression 0.17<ET12<0.3, where ET12 represents a distance on the optical axis from the image-side surface of the first lens L1 to a position where the object-side surface of the second lens L2 has a maximum optical clear aperture. ET12 includes a thickness of the infrared cut-off filter. In other words, ET12 may be any value ranging from 0.17 to 0.3. For example, ET12 may be 0.18, 0.20, 0.22, 0.25, 0.28, and 0.29, etc. When the value of ET12 ranges from 0.17 to 0.3, the optical imaging system can be assembled in a stable manner, which overcomes a problem that there are large differences among steps within a lens barrel and lowers a cost of the optical imaging system.

In some implementations, the optical imaging system 100 satisfies the expression 0.4<ET23<0.8, where ET23 represents a distance on the optical axis from the image-side surface of the second lens L2 to a position where the object-side surface of the third lens L3 has a maximum optical clear aperture. ET23 includes the thickness of the infrared cut-off filter. In other words, ET23 may be any value ranging from 0.4 to 0.8. For example, ET23 may be 0.41, 0.45, 0.5, 0.55, 0.6, 0.7, and 0.79, etc. Air space among the lenses of the three-piece optical imaging system is relatively large, which is not beneficial to forming the lens barrel. In addition, the production yield is unstable due to a large step. The infrared cut-off filter is located between the second lens and the third lens, which can reduce the air space between the second lens and the third lens and make the assembly more stable.

In some implementations, the optical imaging system 100 satisfies the expression 0.57<BF<0.82, where BF represents a distance from a vertex of the image-side surface of the third lens L3 to the imaging surface on the optical axis. In other words, BF may be any value ranging from 0.57 to 0.82. For example, BF may be 0.58, 0.6, 0.62, 0.65, 0.70, 0.75, 0.79, and 0.81, etc. When the value of BF ranges from 0.57 to 0.82, the optical imaging system can be ensured a sufficient focus range and the miniaturization at the same time.

The optical imaging system of the disclosure will be further described hereinafter with reference to specific implementations.

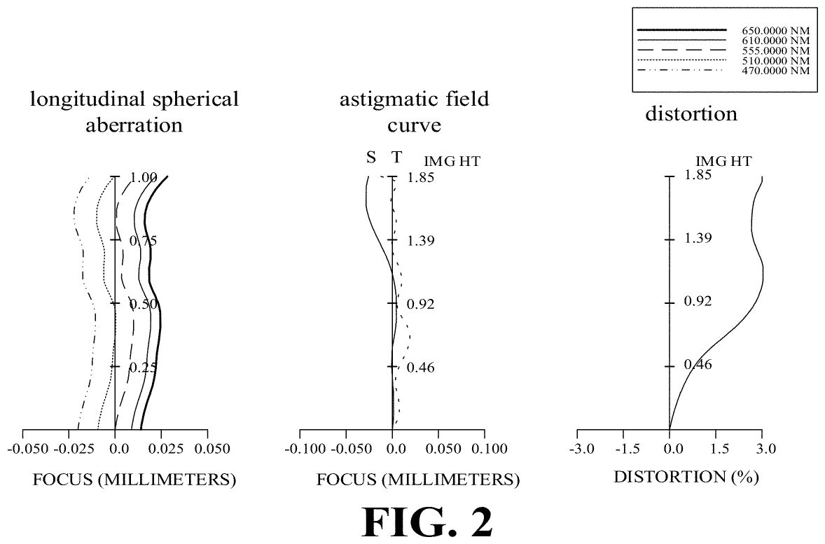

Referring to FIG. 1 and FIG. 2, FIG. 1 is a schematic structural diagram of an optical imaging system 100 according to an implementation of this disclosure. FIG. 2 illustrates a spherical aberration curve, an astigmatic curve, and a distortion curve of the optical imaging system 100 of FIG. 1, from left to right. As illustrated in FIG. 1, the optical system 100 of this implementation includes, from an object side to an image side, a first lens L1 with a positive refractive power, an infrared cut-off filter L4, a second lens L2 with a negative refractive power, a third lens L3 with a positive refractive power, a protective glass L5, and an imaging surface S12. The optical imaging system 100 further includes a stop L0. The stop L0 is located at the object side of the first lens L1.

The first lens L1 is made of plastic. An object-side surface S2 is convex near an optical axis and a periphery of the object-side surface S2 of the first lens L1. An image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. An object-side surface S4 is concave near the optical axis and a periphery of the object-side surface S4 of the second lens L2. An image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. An object-side surface S6 is convex near the optical axis and a periphery of the object-side surface S6 of the third lens L3. An image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the first lens L1 and the second lens L2.

In this implementation, a value of fov, a maximum angle of view of the optical imaging system, is 82.0°. A value of FNO, an f-number of the optical imaging system, is 2.2. A value of TL, a distance from the object-side surface of the first lens L1 to the imaging surface on the optical axis, is 2.68. A value of ImgH, half of a diagonal length of an effective pixel area on the imaging surface, is 1.85. A value of TL/ImgH is 1.447. A value of f, an effective focal length of the optical imaging system, is 1.99. A value of f1, an effective focal length of the first lens L1, is 2.44. A value of f/f1 is 0.816. A value of SD1, half of a maximum optical clear aperture of the object-side surface of the first lens L1, is 0.457. A value of ET12, a distance on the optical axis from the image-side surface of the first lens L1 to a position where the object-side surface of the second lens L2 has a maximum optical clear aperture, is 0.278. A value of ET23, a distance on the optical axis from the image-side surface of the second lens L2 to a position where the object-side surface of the third lens L3 has a maximum optical clear aperture, is 0.462. A value of BF, a distance from a vertex of the image-side surface of the third lens L3 to the imaging surface on the optical axis, is 0.655.

In this implementation, the optical system 100 satisfies the conditions in table 1 and table 2 below.

TABLE 1
Optical imaging system of FIG. 1
EFL = 1.99, FNO = 2.2, FOV = 82.0, TTL = 2.68

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.133 | | | | |
| S2 | First lens | Aspheric | 0.881 | 0.307 | Plastic | 1.544 | 56.114 | 2.44 |
| S3 | | Aspheric | 2.279 | 0.100 | | | | |
| S8 | Infrared | Aspheric | Infinity | 0.210 | Glass | 1.523 | 54.517 | |
| S9 | cut-off | Aspheric | Infinity | 0.204 | | | | |
| | filter | | | | | | | |
| S4 | Second | Aspheric | −1.632 | 0.354 | Plastic | 1.544 | 56.114 | −14.86 |
| S5 | lens | Aspheric | −2.199 | 0.281 | | | | |
| S6 | Third | Aspheric | 0.596 | 0.349 | Plastic | 1.544 | 56.114 | 6.28 |
| S7 | lens | Aspheric | 0.572 | 0.259 | | | | |
| S10 | Protective | Spheric | Infinity | 0.400 | Glass | 1.523 | 54.517 | |
| S11 | glass | Spheric | Infinity | 0.214 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 2
Aspheric coefficients of optical imaging system of FIG. 1

| Surface | | | | | | |
|---|---|---|---|---|---|---|
| Number | S2 | S3 | S4 | S5 | S6 | S7 |
| K | −1.5377E+01 | 1.7067E+01 | −5.3010E−02 | 4.7436E+00 | −4.5396E+00 | −8.5786E−01 |
| A4 | 2.7565E+00 | 2.5603E−02 | −1.2154E+00 | −2.4894E+00 | −4.1841E−01 | −1.7073E+00 |
| A6 | −1.1644E+01 | 1.7490E+00 | 9.2308E+00 | 1.4755E+01 | −1.4755E+00 | 2.3012E+00 |
| A8 | −1.9697E+02 | −6.7721E+01 | −1.1655E+02 | −7.7662E+01 | 4.2685E+00 | −3.2129E+00 |
| A10 | 7.0655E+03 | 1.5857E+03 | 9.8246E+02 | 2.3667E+02 | −5.5001E+00 | 3.8798E+00 |
| A12 | −9.9574E+04 | −2.1470E+04 | −5.7469E+03 | −1.3443E+02 | 3.9915E+00 | −3.7035E+00 |
| A14 | 7.8307E+05 | 1.7486E+05 | 2.1754E+04 | −1.6444E+03 | −1.2999E+00 | 2.4891E+00 |
| A16 | −3.5490E+06 | −8.3640E+05 | −4.7740E+04 | 5.8039E+03 | −1.5779E−01 | −1.0745E+00 |
| A18 | 8.6586E+06 | 2.1594E+06 | 5.3422E+04 | −7.9573E+03 | 2.3355E−01 | 2.6452E−01 |
| A20 | −8.8111E+06 | −2.3148E+06 | −2.2576E+04 | 4.0304E+03 | −4.6680E−02 | −2.8175E−02 |

Table 2 illustrates aspherical data of the optical imaging system of FIG. 1, where k represents a conic coefficient of each of the surfaces. A4 to A20 represent the fourth to twentieth order aspherical coefficients of each of the surfaces.

As illustrated in FIG. 2, upon satisfying demand for an ultra-thin and miniaturization, aberration of the optical imaging system in this disclosure can still be arranged within a proper range, which ensures imaging quality.

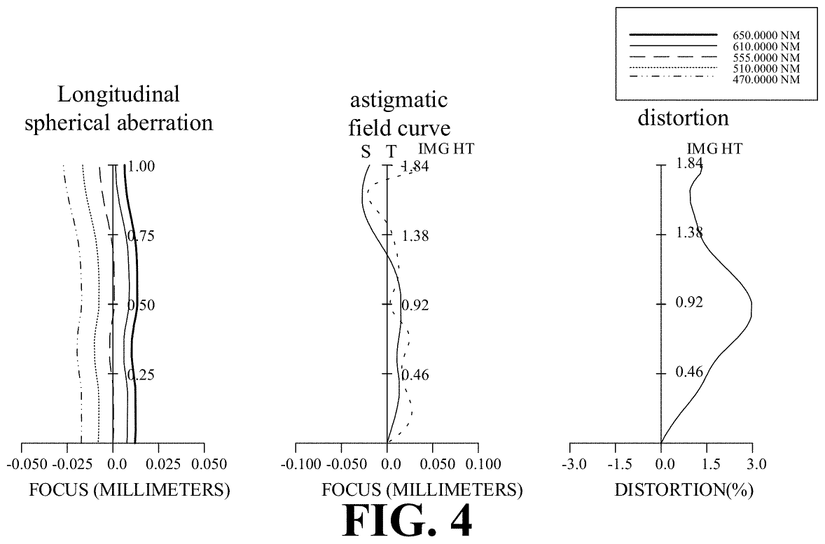

Referring to FIG. 3 and FIG. 4, FIG. 3 is a schematic structural diagram of the optical imaging system 100 according to an implementation of this disclosure. FIG. 4 illustrates the spherical aberration curve, the astigmatic curve, and the distortion curve of the optical imaging system of FIG. 3, from left to right. As illustrated in FIG. 3, the optical system 100 of this implementation includes, from the object side to the image side, the first lens L1 with the positive refractive power, the infrared cut-off filter L4, the second lens L2 with the negative refractive power, the third lens L3 with the positive refractive power, the protective glass L5, and the imaging surface S12. The optical imaging system 100 further includes the stop L0. The stop L0 is located at the object side of the first lens L1.

The first lens L1 is made of plastic. The object-side surface S2 is convex near the optical axis and the periphery of the object-side surface S2 of the first lens L1. The image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. The object-side surface S4 is concave near the optical axis and the periphery of the object-side surface S4 of the second lens L2. The image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. The object-side surface S6 is convex near the optical axis and the periphery of the object-side surface S6 of the third lens L3. The image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the first lens L1 and the second lens L2.

In this implementation, the value of fov, the maximum angle of view of the optical imaging system, is 91.0°. The value of FNO, the f-number of the optical imaging system, is 2.4. The value of TL, the distance from the object-side surface of the first lens L1 to the imaging surface on the optical axis, is 2.53. The value of ImgH, half of the diagonal length of the effective pixel area on the imaging surface, is 1.85. The value of TL/ImgH is 1.386. The value of f, the effective focal length of the optical imaging system, is 1.79. The value of f1, the effective focal length of the first lens L1, is 2.44. The value of f/f1 is 0.734. The value of SD1, half of the maximum optical clear aperture of the object-side surface of the first lens L1, is 0.378. The value of ET12, the distance on the optical axis from the image-side surface of the first lens L1 to the position where the object-side surface of the second lens L2 has the maximum optical clear aperture, is 0.268. The value of ET23, the distance on the optical axis from the image-side surface of the second lens L2 to the position where the object-side surface of the third lens L3 has the maximum optical clear aperture, is 0.417. The value of BF, the distance from the vertex of the image-side surface of the third lens L3 to the imaging surface on the optical axis, is 0.573.

In this implementation, the optical system 100 satisfies the conditions in table 3 and table 4 below.

TABLE 3
Optical imaging system of FIG.
EFL = 1.79, FNO = 2.4, FOV = 91.0, TTL = 2.53

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.087 | | | | |
| S2 | First lens | Aspheric | 0.866 | 0.276 | Plastic | 1.544 | 56.114 | 2.44 |
| S3 | | Aspheric | 2.202 | 0.100 | | | | |
| S8 | Infrared | Aspheric | Infinity | 0.210 | Glass | 1.523 | 54.517 | |
| S9 | cut-off | Aspheric | Infinity | 0.144 | | | | |
| | filter | | | | | | | |
| S4 | Second | Aspheric | −1.772 | 0.359 | Plastic | 1.544 | 56.114 | −41.57 |
| S5 | lens | Aspheric | −2.059 | 0.264 | | | | |
| S6 | Third | Aspheric | 0.593 | 0.379 | Plastic | 1.544 | 56.114 | 5.60 |
| S7 | lens | Aspheric | 0.570 | 0.227 | | | | |
| S10 | Protective | Apheric | Infinity | 0.400 | Glass | 1.523 | 54.517 | |
| S11 | glass | Apheric | Infinity | 0.171 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 4
Aspheric coefficients of the optical imaging system of FIG. 3

| Surface | | | | | | |
|---|---|---|---|---|---|---|
| Number | S2 | S3 | S4 | S5 | S6 | S7 |
| K | −1.5949E+01 | 1.7871E+01 | −4.8480E+00 | 3.4431E+00 | −4.7872E+00 | −8.5656E−01 |
| A4 | 3.0436E+00 | −7.0937E−02 | −5.6741E−01 | −2.0037E+00 | −4.3720E−01 | −1.6658E+00 |
| A6 | −9.7554E+00 | 5.9979E+00 | −1.4293E+01 | 3.2966E+00 | −1.1725E+00 | 2.3016E+00 |
| A8 | −5.5429E+02 | −9.8873E+01 | 3.7915E+02 | 6.1770E+01 | 1.8120E+00 | −3.6146E+00 |
| A10 | 2.0830E+04 | 2.8242E+02 | −5.5546E+03 | −8.1704E+02 | 9.4828E−01 | 4.9772E+00 |
| A12 | −3.7375E+05 | 1.6704E+04 | 4.8283E+04 | 4.9568E+03 | −4.8476E+00 | −5.2671E+00 |
| A14 | 3.9122E+06 | −2.7803E+05 | −2.5852E+05 | −1.7435E+04 | 6.1124E+00 | 3.8117E+00 |
| A16 | −2.4075E+07 | 2.0018E+06 | 8.4052E+05 | 3.6164E+04 | −4.0558E+00 | −1.7349E+00 |
| A18 | 8.0603E+07 | −7.1223E+06 | −1.5170E+06 | −4.0637E+04 | 1.4165E+00 | 4.4374E−01 |
| A20 | −1.1321E+08 | 1.0237E+07 | 1.1622E+06 | 1.8975E+04 | −2.0366E−01 | −4.8549E−02 |

Table 4 illustrates the aspherical data of the optical imaging system of FIG. 3, where k represents the conic coefficient of each of the surfaces. A4 to A20 represent the fourth to twentieth order aspherical coefficients of each of the surfaces.

As illustrated in FIG. 4, upon satisfying the demand for the ultra-thin and miniaturization, the aberration of the optical imaging system in this disclosure can still be arranged within the proper range, which ensures the imaging quality.

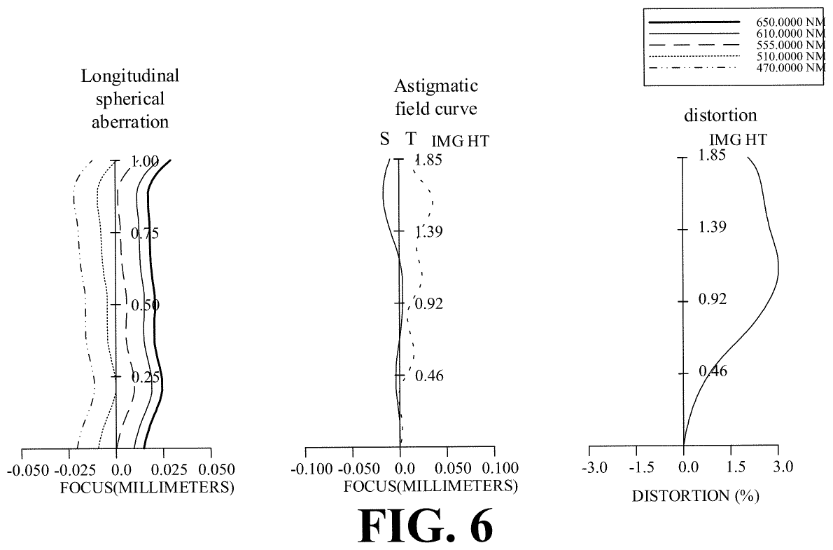

Referring to FIG. 5 and FIG. 6, FIG. 5 is a schematic structural diagram of the optical imaging system 100 according to an implementation of this disclosure. FIG. 6 illustrates the spherical aberration curve, the astigmatic curve, and the distortion curve of the optical imaging system of FIG. 5, from left to right. As illustrated in FIG. 5, the optical system 100 of this implementation includes, from the object side to the image side, the first lens L1 with the positive refractive power, the infrared cut-off filter L4, the second lens L2 with the negative refractive power, the third lens L3 with the positive refractive power, the protective glass L5, and the imaging surface S12. The optical imaging system 100 further includes the stop L0. The stop L0 is located at the object side of the first lens L1.

The first lens L1 is made of plastic. The object-side surface S2 is convex near the optical axis and the periphery of the object-side surface S2 of the first lens L1. The image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. The object-side surface S4 is concave near the optical axis and the periphery of the object-side surface S4 of the second lens L2. The image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. The object-side surface S6 is convex near the optical axis and concave near the periphery of the object-side surface S6 of the third lens L3. The image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the first lens L1 and the second lens L2.

In this implementation, the value of fov, the maximum angle of view of the optical imaging system, is 83.4°. The value of FNO, the f-number of the optical imaging system, is 2.5. The value of TL, the distance from the object-side surface of the first lens L1 to the imaging surface on the optical axis, is 2.67. The value of ImgH, half of the diagonal length of the effective pixel area on the imaging surface, is 1.85. The value of TL/ImgH is 1.443. The value of f, the effective focal length of the optical imaging system, is 2.03. The value of f1, the effective focal length of the first lens L1, is 2.47. The value of f/f1 is 0.822. The value of SD1, half of the maximum optical clear aperture of the object-side surface of the first lens L1, is 0.413. The value of ET12, the distance on the optical axis from the image-side surface of the first lens L1 to the position where the object-side surface of the second lens L2 has the maximum optical clear aperture, is 0.278. The value of ET23, the distance on the optical axis from the image-side surface of the second lens L2 to the position where the object-side surface of the third lens L3 has the maximum optical clear aperture, is 0.450. The value of BF, the distance from the vertex of the image-side surface of the third lens L3 to the imaging surface on the optical axis, is 0.700.

In this implementation, the optical system 100 satisfies the conditions in table 5 and table 6 below.

TABLE 5
Optical imaging system of FIG. 5
EFL = 2.03, FNO = 2.51, FOV = 83.36, TTL = 2.67

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.104 | | | | |
| S2 | First | Aspheric | 0.856 | 0.309 | Plastic | 1.544 | 56.114 | 2.47 |
| S3 | lens | Aspheric | 2.052 | 0.117 | | | | |
| S8 | Infrared | Aspheric | Infinity | 0.210 | Glass | 1.523 | 54.517 | |
| S9 | cut-off | Aspheric | Infinity | 0.188 | | | | |
| | filter | | | | | | | |
| S4 | Second | Aspheric | −1.551 | 0.320 | Plastic | 1.544 | 56.114 | −15.55 |
| S5 | lens | Aspheric | −2.035 | 0.284 | | | | |
| S6 | Third | Aspheric | 0.593 | 0.332 | Plastic | 1.544 | 56.114 | 6.70 |
| S7 | lens | Aspheric | 0.567 | 0.276 | | | | |
| S10 | Protective | Spheric | Infinity | 0.400 | Glass | 1.523 | 54.517 | |
| S11 | glass | Spheric | Infinity | 0.235 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 6
Aspheric coefficients of the optical imaging system of FIG. 5

| Surface | | | | | | |
|---|---|---|---|---|---|---|
| Number | S2 | S3 | S4 | S5 | S6 | S7 |
| K | −1.6208E+01 | 1.6066E+01 | −2.9105E−01 | 3.9925E+00 | −4.6820E+00 | −8.5604E−01 |
| A4 | 3.0333E+00 | 1.3036E−01 | −9.9264E−01 | −2.4499E+00 | −2.4206E−01 | −1.6582E+00 |
| A6 | −5.5942E+00 | −7.0870E+00 | −3.3716E−01 | 1.6333E+01 | −2.5036E+00 | 1.7183E+00 |
| A8 | −6.1712E+02 | 2.4433E+02 | 7.8326E+01 | −1.1646E+02 | 6.9919E+00 | −1.3535E+00 |
| A10 | 1.8221E+04 | −4.7832E+03 | −1.5205E+03 | 5.9205E+02 | −9.6542E+00 | 5.3838E−01 |
| A12 | −2.6926E+05 | 5.6687E+04 | 1.4328E+04 | −1.9170E+03 | 7.4594E+00 | −7.0919E−03 |
| A14 | 2.3473E+06 | −4.1145E+05 | −7.9113E+04 | 3.5671E+03 | −2.3751E+00 | −7.2092E−02 |
| A16 | −1.2134E+07 | 1.7869E+06 | 2.6091E+05 | −2.9817E+03 | −6.3661E−01 | 6.2523E−03 |
| A18 | 3.4397E+07 | −4.2592E+06 | −4.7057E+05 | 7.3533E+00 | 6.9388E−01 | 1.0984E−02 |
| A20 | −4.1217E+07 | 4.2790E+06 | 3.5465E+05 | 9.8811E+02 | −1.4605E−01 | −2.8868E−03 |

Table 6 illustrates the aspherical data of the optical imaging system of FIG. 5, where k represents the conic coefficient of each of the surfaces. A4 to A20 represent the fourth to twentieth order aspherical coefficients of each of the surfaces.

As illustrated in FIG. 6, upon satisfying the demand for the ultra-thin and miniaturization, the aberration of the optical imaging system in this disclosure can still be arranged within the proper range, which ensures the imaging quality.

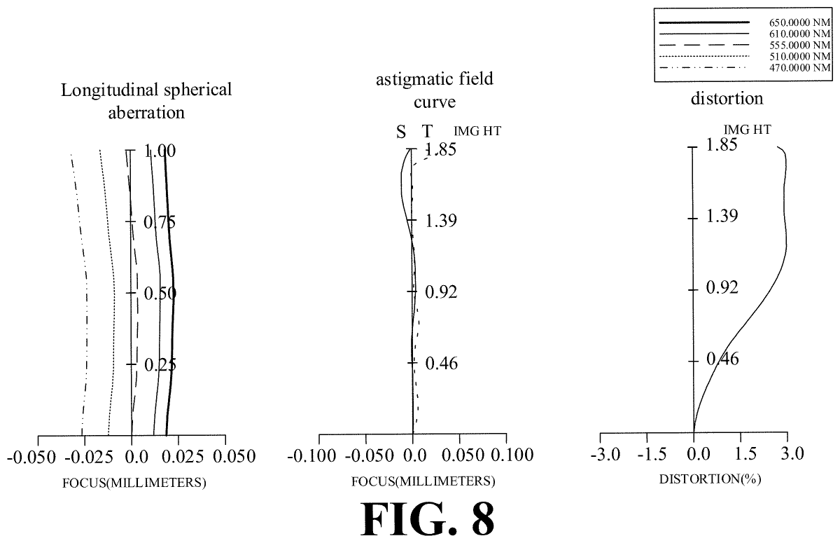

Referring to FIG. 7 and FIG. 8, FIG. 7 is a schematic structural diagram of the optical imaging system 100 according to an implementation of this disclosure. FIG. 8 illustrates the spherical aberration curve, the astigmatic curve, and the distortion curve of the optical imaging system of FIG. 7, from left to right. As illustrated in FIG. 7, the optical system 100 of this implementation includes, from the object side to the image side, the first lens L1 with the positive refractive power, the second lens L2 with the negative refractive power, the infrared cut-off filter L4, the third lens L3 with the positive refractive power, the protective glass L5, and the imaging surface S12. The optical imaging system 100 further includes the stop L0. The stop L0 is located at the object side of the first lens L1.

The first lens L1 is made of plastic. The object-side surface S2 is convex near the optical axis and the periphery of the object-side surface S2 of the first lens L1. The image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. The object-side surface S4 is concave near the optical axis and the periphery of the object-side surface S4 of the second lens L2. The image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. The object-side surface S6 is convex near the optical axis and concave near the periphery of the object-side surface S6 of the third lens L3. The image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the second lens L2 and the third lens L3.

In this implementation, the value of fov, the maximum angle of view of the optical imaging system, is 72.8°. The value of FNO, the f-number of the optical imaging system, is 3.0. The value of TL, the distance from the object-side surface of the first lens L1 to the imaging surface on the optical axis, is 3. The value of ImgH, half of the diagonal length of the effective pixel area on the imaging surface, is 1.85. The value of TL/ImgH is 1.622. The value of f, the effective focal length of the optical imaging system, is 2.436. The value of f1, the effective focal length of the first lens L1, is 2.5. The value of f/f1 is 0.974. The value of SD1, half of the maximum optical clear aperture of the object-side surface of the first lens L1, is 0.409. The value of ET12, the distance on the optical axis from the image-side surface of the first lens L1 to the position where the object-side surface of the second lens L2 has the maximum optical clear aperture, is 0.298. The value of ET23, the distance on the optical axis from the image-side surface of the second lens L2 to the position where the object-side surface of the third lens L3 has the maximum optical clear aperture, is 0.720. The value of BF, the distance from the vertex of the image-side surface of the third lens L3 to the imaging surface on the optical axis, is 0.820.

In this implementation, the optical system 100 satisfies the conditions in table 7 and table 8 below.

TABLE 7
Optical imaging system of FIG. 7
EFL = 2.436, FNO = 3.0, FOV = 72.8, TTL = 3

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.111 | | | | |
| S2 | First | Aspheric | 0.854 | 0.326 | Plastic | 1.544 | 56.114 | 2.50 |
| S3 | lens | Aspheric | 1.974 | 0.517 | | | | |
| S8 | Second | Aspheric | −1.761 | 0.343 | Plastic | 1.544 | 56.114 | −5.40 |
| S9 | lens | Aspheric | −4.669 | 0.033 | | | | |
| S4 | Infrared | Spheric | Infinity | 0.300 | Glass | 1.523 | 54.517 | |
| S5 | cut-off | Spheric | Infinity | 0.120 | | | | |
| | filter | | | | | | | |
| S6 | Third | Aspheric | 0.597 | 0.312 | Plastic | 1.544 | 56.114 | 5.56 |
| S7 | lens | Aspheric | 0.606 | 0.342 | | | | |
| S10 | Protective | Spheric | Infinity | 0.400 | Glass | 1.523 | 54.517 | |
| S11 | glass | Spheric | Infinity | 0.301 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 8
Aspheric coefficients of the optical imaging system of FIG. 7

| Surface | | | | | | |
|---|---|---|---|---|---|---|
| Number | S2 | S3 | S4 | S5 | S6 | S7 |
| K | −1.5173E+01 | 1.3306E+01 | −3.3642E+00 | 6.9833E−01 | −3.7599E+00 | −8.5587E−01 |
| A4 | 3.1006E+00 | −1.4541E−02 | −1.1408E+00 | −1.9912E+00 | −1.8220E−01 | −1.3311E+00 |
| A6 | −2.3422E+01 | 7.9518E−01 | 7.3956E+00 | 1.1611E+01 | −1.5032E+00 | 1.1293E+00 |
| A8 | 1.7690E+02 | −1.8019E+01 | −9.1524E+01 | −6.6906E+01 | 4.1189E+00 | −6.4311E−01 |
| A10 | −5.0689E+02 | 2.2301E+02 | 9.0074E+02 | 2.9739E+02 | −5.9478E+00 | −3.2373E−02 |
| A12 | −6.9712E+03 | −1.5072E+03 | −6.4402E+03 | −9.1594E+02 | 5.3768E+00 | 3.4338E−01 |
| A14 | 9.9349E+04 | 4.9965E+03 | 3.0624E+04 | 1.8591E+03 | −2.9629E+00 | −2.5653E−01 |
| A16 | −5.7147E+05 | −3.7664E+03 | −9.0552E+04 | −2.3175E+03 | 9.2057E−01 | 8.8398E−02 |
| A18 | 1.6240E+06 | −2.0016E+04 | 1.5082E+05 | 1.5870E+03 | −1.3398E−01 | −1.2879E−02 |
| A20 | −1.8611E+06 | 3.7715E+04 | −1.0914E+05 | −4.5435E+02 | 4.5125E−03 | 2.2325E−04 |

Table 8 illustrates the aspherical data of the optical imaging system of FIG. 7, where k represents the conic coefficient of each of the surfaces. A4 to A20 represent the fourth to twentieth order aspherical coefficients of each of the surfaces.

As illustrated in FIG. 8, upon satisfying the demand for the ultra-thin and miniaturization, the aberration of the optical imaging system in this disclosure can still be arranged within the proper range, which ensures the imaging quality.

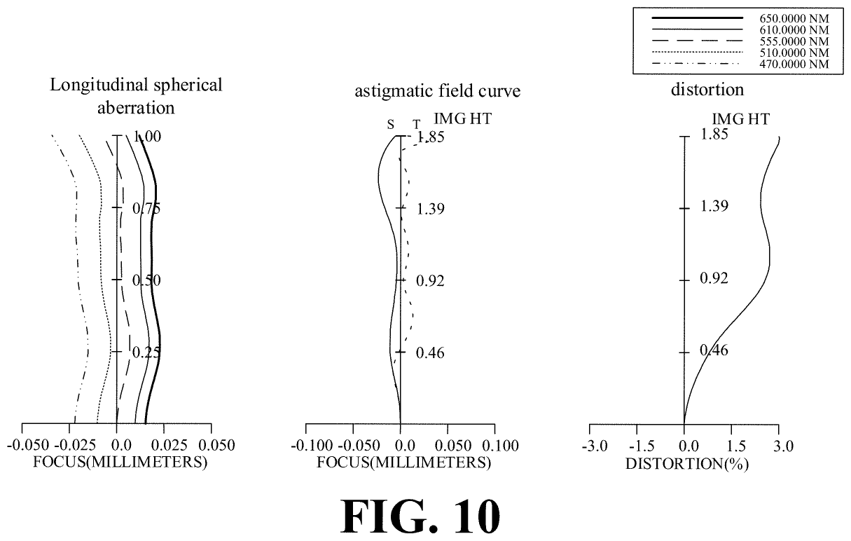

Referring to FIG. 9 and FIG. 10, FIG. 9 is a schematic structural diagram of the optical imaging system 100 according to an implementation of this disclosure. FIG. 10 illustrates the spherical aberration curve, the astigmatic curve, and the distortion curve of the optical imaging system of FIG. 9, from left to right. As illustrated in FIG. 9, the optical system 100 of this implementation includes, from the object side to the image side, the first lens L1 with the positive refractive power, the second lens L2 with the negative refractive power, the infrared cut-off filter L4, the third lens L3 with the positive refractive power, the protective glass L5, and the imaging surface S12. The optical imaging system 100 further includes the stop L0. The stop L0 is located at the object side of the first lens L1.

The first lens L1 is made of plastic. The object-side surface S2 is convex near the optical axis and the periphery of the object-side surface S2 of the first lens L1. The image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. The object-side surface S4 is concave near the optical axis and the periphery of the object-side surface S4 of the second lens L2. The image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. The object-side surface S6 is convex near the optical axis and the periphery of the object-side surface S6 of the third lens L3. The image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the second lens L2 and the third lens L3.

In this implementation, the value of fov, the maximum angle of view of the optical imaging system, is 80°. The value of FNO, the f-number of the optical imaging system, is 2.3. The value of TL, the distance from the object-side surface of the first lens L1 to the imaging surface on the optical axis, is 2.8. The value of ImgH, half of the diagonal length of the effective pixel area on the imaging surface, is 1.85. The value of TL/ImgH is 1.514. The value of f, the effective focal length of the optical imaging system, is 2.13. The value of f1, the effective focal length of the first lens L1, is 2.48. The value of f/f1 is 0.859. The value of SD1, half of the maximum optical clear aperture of the object-side surface of the first lens L1, is 0.468. The value of ET12, the distance on the optical axis from the image-side surface of the first lens L1 to the position where the object-side surface of the second lens L2 has the maximum optical clear aperture, is 0.174. The value of ET23, the distance on the optical axis from the image-side surface of the second lens L2 to the position where the object-side surface of the third lens L3 has the maximum optical clear aperture, is 0.793. The value of BF, the distance from the vertex of the image-side surface of the third lens L3 to the imaging surface on the optical axis, is 0.726.

In this implementation, the optical system 100 satisfies the conditions in table 9 and table 10 below.

TABLE 9
Optical imaging system of FIG. 9
EFL = 2.13, FNO = 2.3, FOV = 80.0, TTL = 2.8

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.146 | | | | |
| S2 | First | Aspheric | 0.848 | 0.316 | Plastic | 1.544 | 56.114 | 2.48 |
| S3 | lens | Aspheric | 1.974 | 0.426 | | | | |
| S8 | Second | Aspheric | −1.472 | 0.304 | Plastic | 1.544 | 56.114 | −9.52 |
| S9 | lens | Aspheric | −2.202 | 0.160 | | | | |
| S4 | Infrared | Spheric | Infinity | 0.300 | Glass | 1.523 | 54.517 | |
| S5 | cut-off | Spheric | Infinity | 0.020 | | | | |
| | filter | | | | | | | |
| S6 | Third | Aspheric | 0.589 | 0.305 | Plastic | 1.544 | 56.114 | 5.34 |
| S7 | lens | Aspheric | 0.603 | 0.304 | | | | |
| S10 | Protective | Spheric | Infinity | 0.400 | Glass | 1.523 | 54.517 | |
| S11 | glass | Spheric | Infinity | 0.263 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 10
Aspheric coefficients of the optical imaging system of FIG. 9

| Surface | | | | | | |
|---|---|---|---|---|---|---|
| Number | S2 | S3 | S4 | S5 | S6 | S7 |
| K | −1.5274E+01 | 1.3912E+01 | 6.1811E−01 | 1.4700E+00 | −3.8637E+00 | −8.5643E−01 |
| A4 | 3.1377E+00 | 1.7111E−02 | −1.4914E+00 | −2.5053E+00 | −4.0510E−02 | −1.1712E+00 |
| A6 | −2.4578E+01 | 2.7312E−01 | 1.0928E+01 | 2.0619E+01 | −1.4847E+00 | 7.2729E−01 |
| A8 | 2.6957E+02 | −6.1333E+01 | −1.5026E+02 | −1.8038E+02 | 2.5257E+00 | −2.5988E−01 |
| A10 | −3.2234E+03 | 1.6356E+03 | 1.6665E+03 | 1.1352E+03 | −1.4839E+00 | −3.1155E−03 |
| A12 | 3.3737E+04 | −2.1023E+04 | −1.4015E+04 | −4.7553E+03 | −5.8886E−01 | −1.0086E−01 |
| A14 | −2.4601E+05 | 1.5077E+05 | 7.9870E+04 | 1.2872E+04 | 1.5168E+00 | 2.1989E−01 |
| A16 | 1.1082E+06 | −6.1532E+05 | −2.8445E+05 | −2.1482E+04 | −1.0075E+00 | −1.6074E−01 |
| A18 | −2.7441E+06 | 1.3331E+06 | 5.7180E+05 | 2.0182E+04 | 3.0951E−01 | 5.3742E−02 |
| A20 | 2.8485E+06 | −1.1887E+06 | −4.9711E+05 | −8.2187E+03 | −3.7582E−02 | −6.9997E−03 |

Table 10 illustrates the aspherical data of the optical imaging system of FIG. 9, where k represents the conic coefficient of each of the surfaces. A4 to A20 represent the fourth to twentieth order aspherical coefficients of each of the surfaces.

As illustrated in FIG. 10, upon satisfying the demand for the ultra-thin and miniaturization, the aberration of the optical imaging system in this disclosure can still be arranged within the proper range, which ensures the imaging quality.

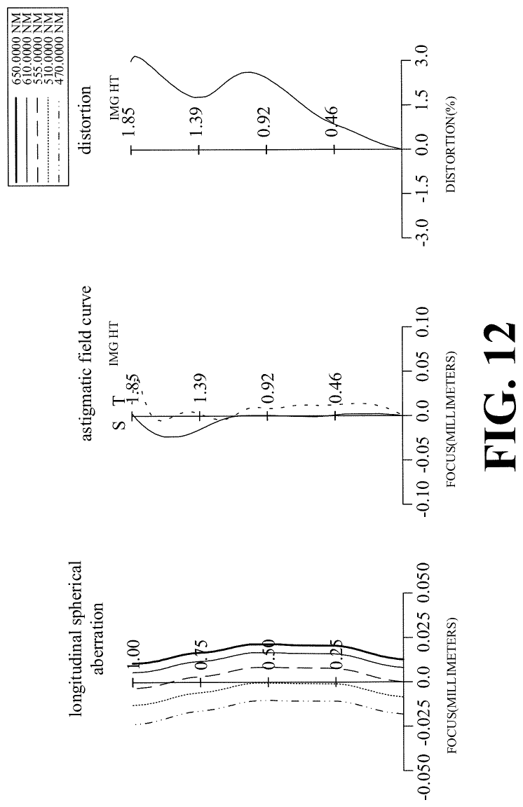

Referring to FIG. 11 and FIG. 12, FIG. 11 is a schematic structural diagram of the optical imaging system 100 according to an implementation of this disclosure. FIG. 12 illustrates the spherical aberration curve, the astigmatic curve, and the distortion curve of the optical imaging system of FIG. 11, from left to right. As illustrated in FIG. 11, the optical system 100 of this implementation includes, from the object side to the image side, the first lens L1 with the positive refractive power, the second lens L2 with the negative refractive power, the infrared cut-off filter L4, the third lens L3 with the positive refractive power, the protective glass L5, and the imaging surface S12. The optical imaging system 100 further includes the stop L0. The stop L0 is located at the object side of the first lens L1.

The first lens L1 is made of plastic. The object-side surface S2 is convex near the optical axis and the periphery of the object-side surface S2 of the first lens L1. The image-side surface S3 is concave near the optical axis and the periphery of the image-side surface S3 of the first lens L1. Both the object-side surface S2 and the image-side surface S3 of the first lens L1 are aspheric.

The second lens L2 is made of plastic. The object-side surface S4 is concave near the optical axis and the periphery of the object-side surface S4 of the second lens L2. The image-side surface S5 is convex near the optical axis and the periphery of the image-side surface S5 of the second lens L2. Both the object-side surface S4 and the image-side surface S5 of the second lens L2 are aspheric.

The third lens L3 is made of plastic. The object-side surface S6 is convex near the optical axis and the periphery of the object-side surface S6 of the third lens L3. The image-side surface S7 is concave near the optical axis and convex near the periphery of the image-side surface S7 of the third lens L3. Both the object-side surface S6 and the image-side surface S7 of the third lens L3 are aspheric.

The infrared cut-off filter L4 is made of glass. The infrared cut-off filter L4 is located between the second lens L2 and the third lens L3.

In this implementation, the value of fov, the maximum angle of view of the optical imaging system, is 89.4°. The value of FNO, the f-number of the optical imaging system, is 2.5. The value of TL, the distance from the object-side surface of the first lens L1 to the imaging surface on the optical axis, is 2.4. The value of ImgH, half of the diagonal length of the effective pixel area on the imaging surface, is 1.85. The value of TL/ImgH is 1.297. The value of f, the effective focal length of the optical imaging system, is 1.81. The value of f1, the effective focal length of the first lens L1, is 2.43. The value of f/f1 is 0.745. The value of SD1, half of the maximum optical clear aperture of the object-side surface of the first lens L1, is 0.366. The value of ET12, the distance on the optical axis from the image-side surface of the first lens L1 to the position where the object-side surface of the second lens L2 has the maximum optical clear aperture, is 0.205. The value of ET23, the distance on the optical axis from the image-side surface of the second lens L2 to the position where the object-side surface of the third lens L3 has the maximum optical clear aperture, is 0.618. The value of BF, the distance from the vertex of the image-side surface of the third lens L3 to the imaging surface on the optical axis, is 0.635.

In this implementation, the optical system 100 satisfies the conditions in table 11 and table 12 below.

TABLE 11
Optical imaging system of FIG. 11
EFL = 1.81, FNO = 2.51, FOV = 89.4, TTL = 2.4

| Surface | Surface | Surface | | | | Refractive | Abbe | Focal |
|---|---|---|---|---|---|---|---|---|
| Number | name | type | Y Radius | Thickness | Material | index | number | length |
| Object | | Spheric | Infinity | 1000.000 | | | | |
| surface | | | | | | | | |
| Stop L0 | | Spheric | Infinity | −0.083 | | | | |
| S2 | First | Aspheric | 0.835 | 0.207 | Plastic | 1.544 | 56.114 | 2.43 |
| S3 | lens | Aspheric | 2.050 | 0.375 | | | | |
| S8 | Second | Aspheric | −1.733 | 0.190 | Plastic | 1.544 | 56.114 | −298.54 |
| S9 | lens | Aspheric | −1.820 | 0.128 | | | | |
| S4 | Infrared | Spheric | Infinity | 0.210 | Glass | 1.523 | 54.517 | |
| S5 | cut-off | Spheric | Infinity | 0.121 | | | | |
| | filter | | | | | | | |
| S6 | Third | Aspheric | 0.586 | 0.304 | Plastic | 1.544 | 56.114 | 6.91 |
| S7 | lens | Aspheric | 0.567 | 0.253 | | | | |
| S10 | Protective | Spheric | Infinity | 0.400 | Glass | 1.523 | 54.517 | |
| S11 | glass | Spheric | Infinity | 0.212 | | | | |
| Imaging | | Spheric | Infinity | 0.000 | | | | |
| surface | | | | | | | | |
| S12 | | | | | | | | |

Note:
a reference wavelength is d-line 587.6 nm

TABLE 12
Aspheric coefficients of the optical imaging system of FIG. 11

| Surface | | | | | | |
|---|---|---|---|---|---|---|
| Number | S2 | S3 | S4 | S5 | S6 | S7 |
| K | −1.4756E+01 | 1.5725E+01 | −1.5393E+00 | −1.5167E+01 | −4.5593E+00 | −8.5534E−01 |
| A4 | 3.0588E+00 | −9.2074E−03 | −2.1621E+00 | −3.1829E+00 | 5.2176E−02 | −1.5913E+00 |
| A6 | −8.7104E+00 | −2.1391E+00 | 1.9290E+01 | 2.3477E+01 | −3.0850E+00 | 1.9695E+00 |
| A8 | −4.6960E+02 | 1.6174E+02 | −2.8721E+02 | −2.2655E+02 | 9.3469E+00 | −2.8147E+00 |
| A10 | 1.5292E+04 | −5.5657E+03 | 3.5015E+03 | 1.7947E+03 | −1.7278E+01 | 3.7928E+00 |
| A12 | −2.3626E+05 | 1.0717E+05 | −3.1005E+04 | −9.8640E+03 | 2.0789E+01 | −4.2287E+00 |
| A14 | 2.1169E+06 | −1.2027E+06 | 1.8229E+05 | 3.4838E+04 | −1.5752E+01 | 3.2690E+00 |
| A16 | −1.1033E+07 | 7.8359E+06 | −6.4895E+05 | −7.1329E+04 | 7.2152E+00 | −1.5772E+00 |
| A18 | 3.0638E+07 | −2.7472E+07 | 1.2700E+06 | 7.4794E+04 | −1.8272E+00 | 4.2478E−01 |
| A20 | −3.4323E+07 | 4.0063E+07 | −1.0658E+06 | −3.0264E+04 | 1.9673E−01 | −4.8791E−02 |

Table 12 illustrates the aspherical data of the optical imaging system of FIG. 11, where k represents the conic coefficient of each of the surfaces. A4 to A20 represent the fourth to twentieth order aspherical coefficients of each of the surfaces.

As illustrated in FIG. 12, upon satisfying the demand for the ultra-thin and, miniaturization, the aberration of the optical imaging system in this disclosure can still be arranged within the proper range, which ensures the imaging quality.

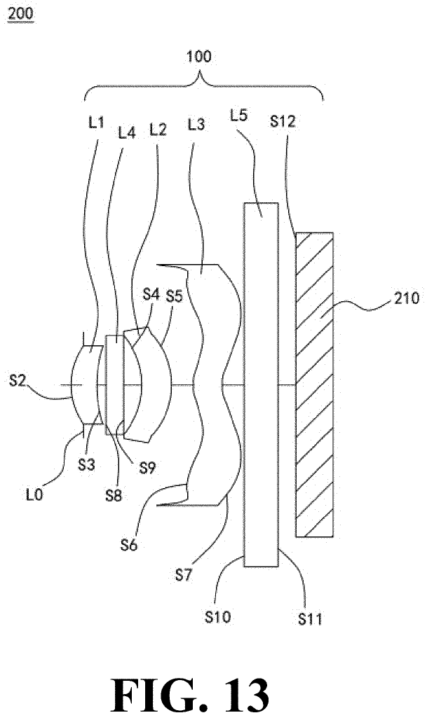

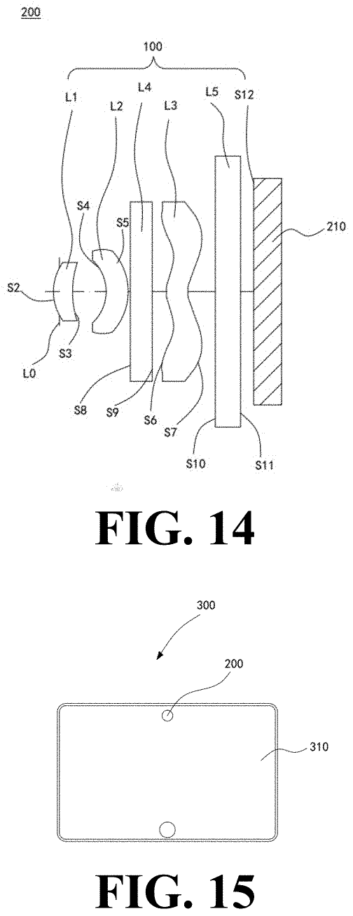

Referring to FIG. 13 and FIG. 14, in a second aspect of this disclosure, an image capturing apparatus 200 is provided. The image capturing apparatus 200 includes the optical imaging system 100 as described in the first aspect and a photosensitive element 210 located on the imaging surface S12 of the optical imaging system 100.

The optical system 100 includes, from the object side to the image side, the stop L0 with the positive refractive power, the first lens L1, the second lens L2 with the negative refractive power, the third lens L3 with the positive refractive power, and the protective glass L5. The optical imaging system 100 further includes the infrared cut-off filter L4. As can be seen in FIG. 13, in some implementations, the infrared cut-off filter L4 is located between the first lens L1 and the second lens L2. As can be seen in FIG. 14, in some implementations, the infrared cut-off filter L4 is located between the first lens L1 and the second lens L2.

The photosensitive element 210 of this disclosure may be a charge coupled device (CCD) or a complementary metal-oxide semiconductor (CMOS sensor).

As for other features of the image capturing apparatus 200, reference can be made to the first aspect of this disclosure, which is not repeated herein.

As can be seen in FIG. 15, in a third aspect of this disclosure, an electronic device 300 is provided. The electronic device 300 includes a body 310 and the image capturing apparatus 200 as described in the second aspect. The image capturing apparatus 200 is installed on the body 310.

The electronic device 300 in this disclosure can include but is not limited to personal computers, laptops, tablet personal computers, a mobile phone, cameras, intelligent bands, intelligent watches, and intelligent glasses, etc.

While this disclosure has been described specifically and in detail above with reference to several implementations, the scope of the present disclosure is not limited thereto. As will occur to those skilled in the art, this disclosure is susceptible to various modifications and changes within the technical range of this disclosure. Any modifications, or improvements that can be made by those skilled in the art shall all be encompassed within the protection of this disclosure. Therefore, the scope of the present disclosure should be determined by the scope of the claims.

What is claimed is:

1. An optical imaging system comprising, in order from an object side to an image side:
a first lens with a positive refractive power;
a second lens with a negative refractive power;
a third lens with a positive refractive power; and
an infrared cut-off filter, wherein the infrared cut-off filter is located between the first lens and the second lens or between the second lens and the third lens.

2. The optical imaging system of claim 1, wherein both an object-side surface and an image-side surface of each of the first lens, the second lens, and the third lens are aspheric, and at least one of the object-side surface or the image-side surface of the third lens has at least one inflection point.

3. The optical imaging system of claim 1, wherein an object-side surface of the first lens is convex near an optical axis and a periphery of the object-side surface of the first lens, and an image-side surface of the first lens is concave near the optical axis and a periphery of the image-side surface of the first lens.

4. The optical imaging system of claim 1, wherein an object-side surface of the second lens is concave near an optical axis and a periphery of the object-side surface of the second lens, and an image-side surface of the second lens is convex near the optical axis and convex near a periphery of the image-side surface of the second lens.

5. The optical imaging system of claim 1, wherein
the object-side surface of the third lens is convex near an optical axis and a periphery of the object-side surface of the third lens, and an image-side surface of the third lens is concave near the optical axis and convex near a periphery of the image-side surface of the third lens; or
the object-side surface of the third lens is convex near the optical axis and concave near the periphery of the object-side surface of the third lens, and the image-side surface of the third lens is concave near the optical axis and convex near the periphery of the image-side surface of the third lens.

6. The optical imaging system of claim 1, further comprising a stop, wherein the stop is located at the object side of the first lens.

7. The optical imaging system of claim 1, further comprising a protective glass, wherein the protective glass is located between the third lens and an imaging surface.

8. The optical imaging system of claim 7, wherein the optical imaging system satisfies the following expression:
72°<fov<91°,
wherein fov represents a maximum angle of view of the optical imaging system.

9. The optical imaging system of claim 7, wherein the optical imaging system satisfies the following expression:
2.2≤FNO≤3.0,
wherein FNO represents an f-number of the optical imaging system.

10. The optical imaging system of claim 7, wherein the optical imaging system satisfying the following expression:
TL/ImgH<1.7,
wherein TL represents a distance from the object-side surface of the first lens to the imaging surface on an optical axis, and ImgH represents half of a diagonal length of an effective pixel area on the imaging surface.

11. The optical imaging system of claim 7, wherein the optical imaging system satisfies the following expression:
0.7<f/f1<1,
wherein f represents an effective focal length of the optical imaging system, and f1 represents an effective focal length of the first lens.

12. The optical imaging system of claim 7, wherein the optical imaging system satisfies the following expression:
SD1≤0.47,
wherein SD1 represents half of a maximum optical clear aperture of the object-side surface of the first lens.

13. The optical imaging system of claim 7, wherein the optical imaging system satisfies the following expression:
0.17<ET12<0.3,
wherein ET12 represents a distance on an optical axis from the image-side surface of the first lens to a position where the object-side surface of the second lens has a maximum optical clear aperture.

14. The optical imaging system of claim 7, wherein the optical imaging system satisfies the following expression:
0.4<ET23<0.8,
wherein ET23 represents a distance on an optical axis from the image-side surface of the second lens to a position where the object-side surface of the third lens has a maximum optical clear aperture.

15. The optical imaging system of claim 7, wherein the optical imaging system satisfies the following expression:
0.57<BF<0.82,
wherein BF represents a distance from a vertex of the image-side surface of the third lens to the imaging surface on an optical axis.

16. An image capturing apparatus, comprising:
an optical imaging system; and
a photosensitive element located on the imaging surface of the optical imaging system;
wherein the optical imaging system comprises, in order from an object side to an image side:
a first lens with a positive refractive power;
a second lens with a negative refractive power;
a third lens with a positive refractive power; and
an infrared cut-off filter, wherein the infrared cut-off filter is located between the first lens and the second lens or between the second lens and the third lens.

17. The image capturing apparatus of claim 16, wherein both an object-side surface and an image-side surface of each of the first lens, the second lens, and the third lens are aspheric, and at least one of the object-side surface or the image-side surface of the third lens has at least one inflection point.

18. The optical imaging system of claim 16, wherein an object-side surface of the first lens is convex near an optical axis and a periphery of the object-side surface of the first lens, and an image-side surface of the first lens is concave near the optical axis and a periphery of the image-side surface of the first lens.

19. The optical imaging system of claim 16, wherein an object-side surface of the second lens is concave near an optical axis and a periphery of the object-side surface of the second lens, and an image-side surface of the second lens is convex near the optical axis and convex near a periphery of the image-side surface of the second lens.

20. An electronic device, comprising:
a body; and
the image capturing apparatus of claim 16, wherein the image capturing apparatus is installed on the body.
